(19) United States
(12) Patent Application Publication
(10) Pub. No.: US 2022/0316158 A1
(43) Pub. Date: Oct. 6, 2022

(54) DIRECTIONAL WARNING SYSTEM AND METHOD

(71) Applicants: Andrew Morrill, Glastonbury, CT (US); Matthew J Patterson, Glastonbury, CT (US)

(72) Inventors: Andrew Morrill, Glastonbury, CT (US); Matthew J Patterson, Glastonbury, CT (US)

(73) Assignee: Wrong Way Technologies LLC, Glastonbury, CT (US)

(21) Appl. No.: 17/597,307

(22) PCT Filed: Aug. 20, 2020
(86) PCT No.: PCT/US20/47089

§ 371 Date: Dec. 31, 2021

Related U.S. Application Data
(60) Provisional application No. 62/943,994, filed on Dec. 5, 2019.
(60) Provisional application No. 62/889,291, filed on Aug. 20, 2019.

(51) Int. Cl. E01F 9/529; G08G 1/09

(52) U.S. Cl. CPC E01F 9/529; G08G 1/09; E01C 23/0993

(57) ABSTRACT

A one-way recessed directional rumble strip system for controlling both direction and speed of traffic is described. The recessed directional rumble strip system includes a plurality of recessed directional rumble strips having a descending surface and a rumble face. Vehicles approaching the recessed directional rumble strip from a correct direction of travel are allowed to pass over the recessed directional rumble strip with little or no effect on the vehicle. Vehicles attempting to pass from the wrong direction will engage the features of the recessed directional rumble strip. This will affect an operating condition of the vehicle to change such as to cause a tactile and audible sensation to the driver. Indicia may be provided on the steep face to warn drivers that they are traveling in the wrong direction.

### CROSS REFERENCE TO RELATED APPLICATIONS

This application claims the benefit of U.S. Provisional Patent Application Ser. No. 62/889,291 filed 20 Aug. 2019 as well as U.S. Provisional Patent Application Ser. No. 62/943,994 filed 5 Dec. 2019. The disclosure of the applications above are incorporated herein by reference in their entirety.

### BACKGROUND OF THE INVENTION

### Field of the Invention

Embodiments of the present disclosure relate to roadway directional warning systems in general and more particularly to a warning system providing visual, audible and tactile feedback to a driver that the driver is proceeding in a direction that opposes the dedicated direction of traffic.

### Description of the Related Art

Wrong-way driving (wrong way driver) on roadways has been identified as a serious traffic safety problem. Drivers who make wrong-way (wrong way) entries onto roadways pose a serious risk to the safety of other motorists and themselves.

Drivers who make wrong way entries onto freeways pose a serious risk to the safety of other motorists and themselves. The National Transportation Safety Board (NTSB) reported that the primary origin of wrong way movement occurs when a driver enters from an exit ramp. wrong way driver crashes are relatively infrequent but are more likely to produce serious injuries and fatalities compared with other types of crashes. A recent study of the Fatality Analysis Reporting System showed that wrong way driver caused between 300 and 400 annual traffic fatalities from 2004 to 2011 in the United States. This number of fatalities has been consistent, even though total traffic fatalities declined by 4% over the eight-year period from 2004 through 2011.

As early as the 1970s, wrong way driver freeway entries raised the attention of transportation agencies. Agencies throughout the world have performed on-site investigations in the state and proposed countermeasures in terms of geometric design, pavement marking, and roadway signage. Other prior art attempts to stop wrong way driver include the counter and surveillance system for off-ramps and the placement of placing “DO NOT ENTER” and “WRONG WAY” signs, along with the wrong way pavement lights (a row of red lights embedded in the pavement across the off-ramp). Some other prior art systems utilize larger versions of “DO NOT ENTER” and “WRONG WAY” signs, lower mounting height, and solar-powered flashing signs.

Some prior art high-technology countermeasures also emerged to reverse the troubling trend of wrong way freeway entries. Such countermeasures include traffic surveillance cameras, vehicle detection equipment, variable message signs, travel time signs, radio frequency identification transponder/readers, highway advisory radio, communication equipment, and central software equipment, wherein some systems inform the errant driver of his or her potentially fatal mistake via visual warnings to prompt drivers into corrective action. The high-tech and other electrically powered countermeasures of the prior art are typically more expensive than passive methods and can be prone to failure.

Despite decades of improvements on design, marking, and signage at freeway interchanges, more efforts should still be taken to mitigate the wrong way driver issue. A recent study by the United States National Transportation Safety Board also concluded that there is a need “to establish—through traffic control devices and improved highway designs—distinctly different views for motorists approaching entrance and exit ramps.”

Prior art attempts to alert drivers to lane drift on roads and highways include center lane rumble strips and shoulder rumble strips. Such prior art rumble strips are comprised of a relatively short, symmetrical shallow radiused divot milled into a road's surface and positioned perpendicular to the flow of traffic. It is the intention of such rumble strips to create noise and vibration inside the vehicle through interaction with the vehicle tires. Often this alert is strong enough to get the attention of a distracted or drowsy driver, who can quickly make a corrective steering action to return to the roadway safely. Rumble strips also alert drivers to the lane limits when conditions such as rain, fog, snow or dust reduce driver visibility. Centerline rumble strips are an effective countermeasure to prevent head-on collisions and opposite-direction sideswipes (often referred to as cross-over or cross-centerline crashes). Centerline rumble strips are primarily used to warn drivers whose vehicles are crossing centerlines of two-lane, two-way roads. Similarly, shoulder rumble strips are an effective means of preventing run-off-the-road crashes. Shoulder rumble strips are primarily used to warn drivers when they have drifted from their lane. Placement of shoulder rumble strips close to the travel lane increases their effectiveness at intercepting and alerting a drifting motorist. The rumble strips, being symmetrical in nature, have the same effect on a vehicle regardless of the direction of travel. As such, these prior art rumble strips are not an effective solution to alerting a wrong way driver without affecting a driver travelling in the proper direction on limited access highways. Such symmetrical rumble strips are milled into a roadway using a cylindrical drum producing an arc section that is a mirror image of the drum. One such prior art patent for producing symmetrical rumble strips is disclosed in U.S. Pat. No. 6,210,071 which discloses a generally cylindrical cutting drum, including cutting teeth, that is disposed generally parallel to the surface of the roadway. The cutting drum is maintained at a predetermined position with respect to the surface of the roadway such that the cutting teeth cut into the surface at a relatively constant, predetermined depth.

Other prior art attempts at passive countermeasures to prevent wrong way driver are outlined in detail in a recent report published by Roadway Safety Institute entitled “Directional Rumble Strips for Reducing Wrong-Way-Driving” report number CTS 19-25 published July 2019 (the CTS 19-25 report). This report discusses prior art features referred to as directional rumble strips (DRS) placed on top of a road way surface to provide a tactile sensation and audio alert to a wrong way driver and to be relatively inert to drivers travelling in a correct designated direction. A common problem amongst the various features disclosed is that the DRS's are placed on top of the road surface making them vulnerable to damage and removal, and a hazard for snow removal. In addition, these above-the-pavement directional rumble strips are symmetrical in shape and as such are highly perceptible to drivers travelling in the designated direction of travel.

Another prior art attempt to provide a one-way speed bump is set forth in US20070258764 (the '764 application) and is similar to the directional rumble strip set forth in the CTS 19-25 report in that they are bolted to the top of the road surface making them vulnerable to damage and removal, and a hazard for snow removal. In addition, the one-way speed bump of the '764 application includes steep rear face that, as disclosed in the abstract, could possibly damage a vehicle travelling in the wrong way direction. There are situations wherein vehicles need to travel in the wrong-way direction, such as first responders, and such features would have a deleterious effect to these vehicles. Another similar prior art system for providing a tactile directional indication to a driver is set forth in U.S. Pat. No. 7,077,600 (the '600 patent) which discloses an elevated marking tape that is adhered to the top of the road surface, and similar to above-the-pavement directional rumble strips set forth in the CTS 19-25 report, making them vulnerable to damage and removal, and a hazard for snow removal.

What is needed is a reliable, efficient and adaptable permanent countermeasure to wrong way driver on the roadways that eliminates the problems of the prior art.

### SUMMARY OF THE INVENTION

One general aspect of the present disclosure includes a recessed directional rumble strip positioned below a top surface of pavement of a roadway. The recessed directional rumble strip also includes a descending surface projecting downwardly from the top surface of pavement. The strip also includes a rumble face descending from the top surface of pavement and intersecting the descending surface. Other embodiments of this aspect include corresponding computer systems, apparatus, and computer programs recorded on one or more computer storage devices, each configured to perform the actions of the methods.

Implementations may include one or more of the following features. The recessed directional rumble strip may include a length that traverses at least a portion of the roadway. The descending surface and the rumble face descend to a depth below the top surface of pavement. The width and the depth are configured to cause a first effect on an operating condition of vehicular traffic approaching from a wrong way direction and where the width and the depth are selected to have a second effect on an operating condition of vehicular traffic approaching from a correct designated direction where the first effect is greater than the second effect. The recessed directional rumble strip may include an impact edge formed at an intersection between the rumble face and the top surface of pavement. The first effect is caused by an interaction of a tire with the recessed directional rumble strip of vehicular traffic approaching from the wrong way direction. The first effect on the operating condition is at least one of an acceleration, an impact force, a tactile sensation, a speed, an audible noise signal and a vibration. A sensor station is configured to sense the operating condition. The sensor station includes at least one of one a sound sensor, a microphone, a vibration sensor, a directional sensor and a temperature sensor. The sensor station includes computer processing equipment configured to process a signal produced by at least one of the sound sensor, the microphone, the vibration sensor, the directional sensor and the temperature sensor and further configured to produce an output signal indicative of a vehicle traveling in the wrong way direction. The computer processing equipment is further configured to learn a plurality of operating conditions indicative of vehicular traffic traveling in the wrong way direction. The first effect is configured to deter vehicular traffic travelling in the wrong way direction. The recessed directional rumble strip may include indicia on the rumble face. The rumble face may include a recess and where the indicia are located within the recess. The recessed directional rumble strip is milled into the top surface of pavement using a profiled cutting drum.

The recessed directional rumble strip system also includes a plurality of recessed directional rumble strips positioned below a top surface of pavement of a roadway, the plurality of recessed directional rumble strips may include: a descending surface descending from the top surface of pavement, and a rumble face descending from the top surface of pavement and intersecting the descending surface.

Implementations may include one or more of the following features. The recessed directional rumble strip system may include the plurality of recessed directional rumble strips may include a length that traverses at least a portion of the roadway. The descending surface and the rumble face of the plurality of recessed directional rumble strips descend to a depth below the top surface of pavement. The second angle and the depth of the plurality of recessed directional rumble strips are configured to cause a first effect on an operating condition of vehicular traffic approaching from a wrong way direction and where the second angle and the depth are configured to cause a second effect on an operating condition of vehicular traffic approaching from a correct designated direction where the first effect is greater than the second effect. The plurality of recessed directional rumble strips are positioned at any of evenly spaced along the top surface of pavement and at varying spacing along the top surface of pavement. The plurality of recessed directional rumble strips are positioned at any of perpendicular to the wrong way direction, at an angle other than perpendicular to the wrong way direction and in a pattern. The sensor station is configured to sense an environmental factor indicative of a vehicle traveling in the wrong way direction. The sensor station includes computer processing equipment configured to process a signal related to the environmental factor and to produce an output signal indicative of a vehicle traveling in the wrong way direction. The computer processing equipment is further configured to learn a plurality of environmental factors indicative of vehicular traffic traveling in the wrong way direction. Implementations of the described techniques may include hardware, a method or process, or computer software on a computer-accessible medium.

One general aspect includes a method of deterring wrong way drivers on a roadway positioning a plurality of recessed directional rumble strips below a top surface of pavement of the roadway, the plurality of recessed directional rumble strip may include: a descending surface descending from the top surface of pavement; and a rumble face descending from the top surface of pavement and intersecting the descending surface.

Implementations may include one or more of the following features. The method where the plurality of recessed directional rumble strips may include a length that traverses at least a portion of the roadway. The descending surface and the rumble face descend to a depth. The width and the depth are selected to have a second effect on an operating condition of vehicular traffic approaching from a correct designated direction where the first effect is greater than the second effect. The method may include forming an impact edge formed at an intersection between the rumble face and the top surface of pavement. The method may include forming the plurality of recessed directional rumble strips into a module, and installing the module below the top surface of pavement. The method may include milling the plurality of recessed directional rumble strips into the top surface of pavement using a profiled cutting drum.

The recessed directional rumble strip system also includes a directional rumble strip module may include a plurality of recessed directional rumble strip positioned, the plurality of recessed directional rumble strip may include: a descending surface descending from a top surface of the directional rumble strip module, and a rumble face descending from the top surface of the directional rumble strip module and intersecting the descending surface, and the directional rumble strip module adapted to be positioned below a top surface of pavement of a roadway.

The directional rumble strip can also include an asymmetric feature positioned below a top surface of a pavement; and the feature is configured to produce any of a tactile sensation and an audible signal to a driver of a vehicle when the vehicle is driven in a wrong way direction.

Implementations may include one or more of the following features. The directional rumble strip may include the feature is configured to produce substantially less of any of the tactile sensation and the audible signal to the driver of the vehicle when the vehicle is driven in a correct designated direction.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a recessed directional rumble strip system in accordance with certain embodiments of the present disclosure.

FIG. 2 is a cross section side view of a recessed directional rumble strip taken along cut line 2-2 in FIG. 1 in accordance with certain embodiments of the present disclosure.

FIG. 3 is a top view of a recessed directional rumble strip system in accordance with certain embodiments of the present disclosure.

FIG. 4 is a top view of a recessed directional rumble strip system in accordance with certain embodiments of the present disclosure.

FIG. 5 is a top view of a recessed directional rumble strip system in accordance with certain embodiments of the present disclosure.

FIG. 6 is a top view of a recessed directional rumble strip system in accordance with certain embodiments of the present disclosure.

FIG. 7 is a top view of a recessed directional rumble strip system in accordance with certain embodiments of the present disclosure.

FIG. 8 is a cross section side view of a recessed directional rumble strip in accordance with certain embodiments of the present disclosure.

FIG. 9 is a side view of a recessed directional rumble strip in accordance with certain embodiments of the present disclosure.

FIG. 10 is a graphical representation of the acceleration versus frequency of a vehicle encountering a recessed directional rumble strip in accordance with certain embodiments of the present disclosure.

FIG. 11 is a perspective view of a modular recessed directional rumble strip in accordance with certain embodiments of the present disclosure.

FIG. 12 is a plan view of a modular recessed directional rumble strip in accordance with certain embodiments of the present disclosure.

FIG. 13 is a cross section side view of a recessed directional rumble strip taken along cut line 13-13 in FIG. 12 in accordance with certain embodiments of the present disclosure.

FIG. 14 is a cross section side view of a recessed directional rumble strip in accordance with certain embodiments of the present disclosure.

FIG. 15 is a cross section side view of a recessed directional rumble strip in accordance with certain embodiments of the present disclosure.

FIG. 16 is a cross section side view of a recessed directional rumble strip in accordance with certain embodiments of the present disclosure.

FIG. 17 is an outline of a profiled cutting drum to produce a recessed directional rumble strip in accordance with certain embodiments of the present disclosure.

FIG. 18 is an outline of a profiled cutting drum to produce a recessed directional rumble strip in accordance with certain embodiments of the present disclosure.

FIG. 19 is an outline of a profiled cutting drum to produce a recessed directional rumble strip in accordance with certain embodiments of the present disclosure.

FIG. 20 is a profiled cutting drum to produce a recessed directional rumble strip in accordance with certain embodiments of the present disclosure.

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

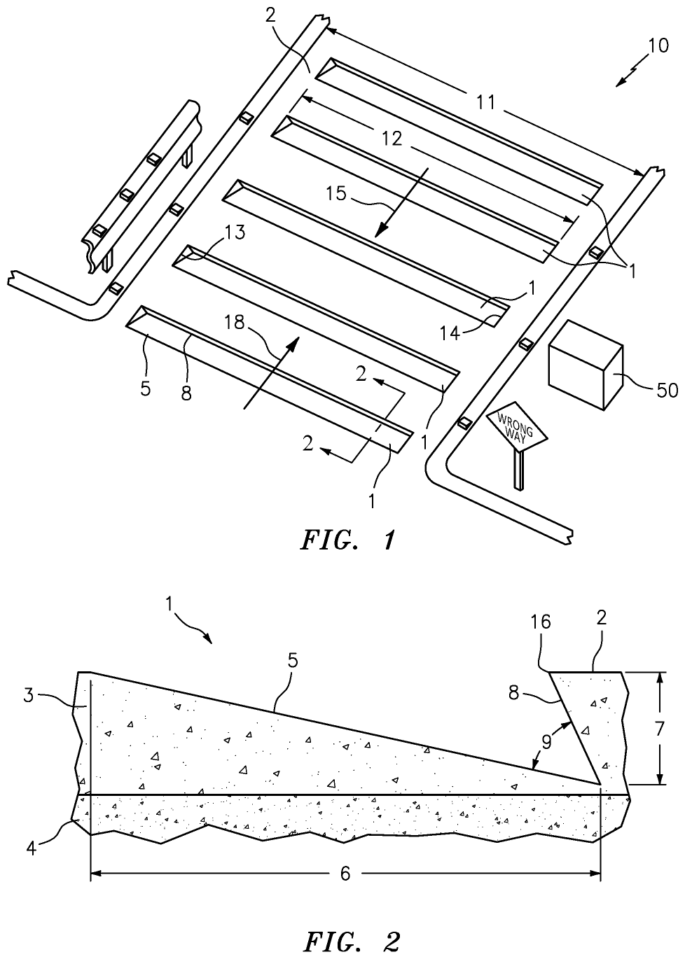

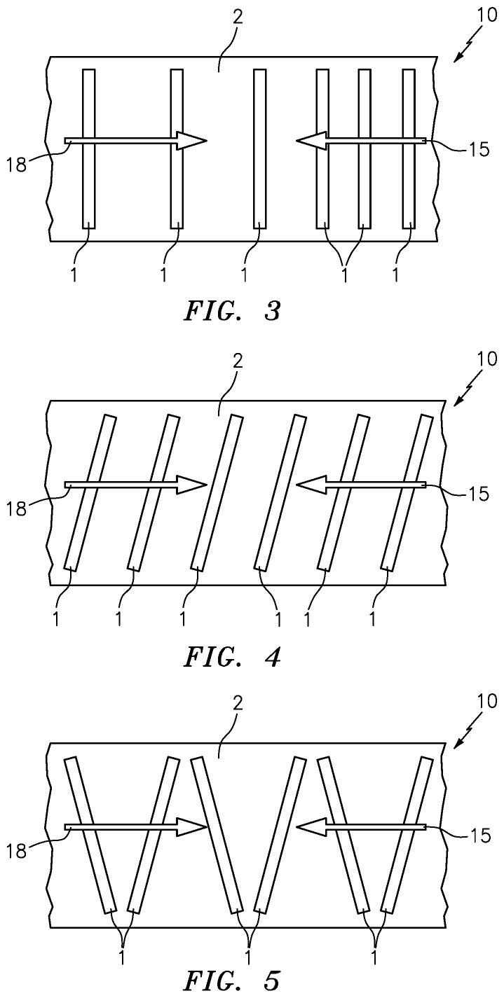

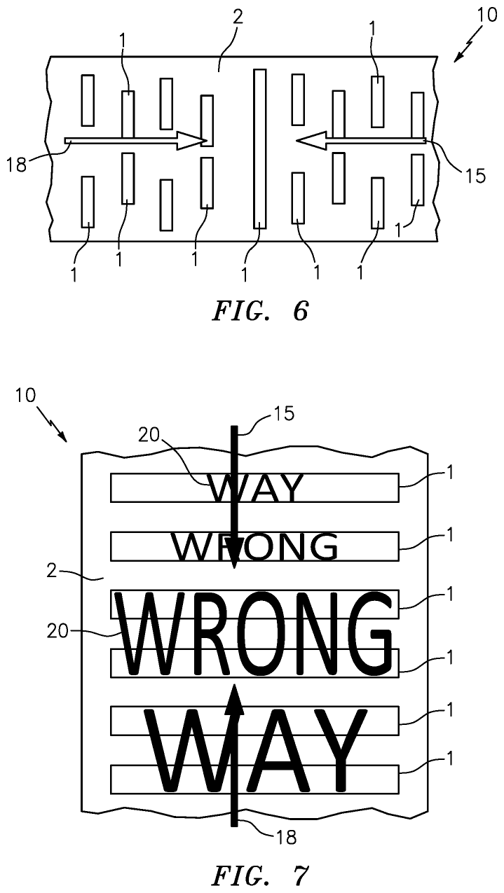

A plurality of recessed directional rumble strips, in the form of a plurality of recessed directional rumble strip 1, according to one embodiment of the present invention is shown in FIGS. 1, 2 as part of recessed directional rumble strip system 10. As used herein, recessed directional rumble strip refers to a directional rumble strip having asymmetrical features that is disposed below the surface of a roadway to produce an effect on an operating condition of vehicular traffic approaching from a wrong way direction and having less, little or no effect on an operating condition of vehicular traffic approaching from a correct designated direction as will be described in more detail herein after. It should be noted that the wrong way direction and the correct designated direction are generally opposing directions. With specific reference to FIG. 2 there is shown a side view of recessed directional rumble strip 1 taken along cut line 2-2 of FIG. 1. Recessed directional rumble strip 1 is formed below top surface 2 of pavement layer 3 that is typically positioned above sublayer 4 using any suitable method including milling, machining, casting, molding and the like and other methods that will be detailed herein below. Recessed directional rumble strip 1 includes a descending surface 5 in the form of a sloped surface that starts at top surface 2 and descends at a preselected angle into pavement layer 3 along width 6 to a total depth 7 within the pavement layer producing an asymmetrical shape with respect to the width. Recessed directional rumble strip 1 further includes rumble face 8 that extends from top surface 2 to descending surface 5 wherein it intersects the sloped surface at angle 9. Although rumble face 8 intersects top surface 2 at less than a right angle in the embodiment shown, other angles are contemplated by the present disclosure as will be described more fully herein below. In addition, although descending surface 5 is shown intersecting with rumble face 8, it does not have to intersect directly with the rumble face, it is within the scope of the present disclosure that there can be one or more surfaces positioned between the descending surface and the rumble face (see, for example, FIG. 16). Impact edge 16 is formed at the intersection of rumble face 8 and top surface 2. The term “pavement” as used herein is not meant to be one of limitation and can be, for example, a roadway, exit ramp, entrance ramp, highway, aisle way, row, sidewalk or parking lot. The term “vehicle” as used herein can refer to any mode of transportation that includes tires including, but without limiting, cars, trucks, motorcycles, bicycles, wheelchairs and the like. The recessed directional rumble strip 1 can have a length 12 and can be positioned such that it traverses all or a portion of the width 11 of pavement 3 within which it is positioned. As used herein, “road” may be used interchangeably with aisle, lane or any other surface upon which vehicles travel. The length 12 of the recessed directional rumble strip 1, shown as 12 in FIG. 1, varies depending on the on the width 11 of the road and may be of any predetermined length is necessary to control traffic, including multiple recessed directional rumble strip spaced longitudinally adjacent to other recessed directional rumble strip. In addition, multiple recessed directional rumble strip 1 can be positioned adjacent to one another along correct designated direction 15 to form recessed directional rumble strip system 10. It should be apparent to those skilled in the art that length 12 of the recessed directional rumble strip is not a limitation of the device. Rather, length 12 is a function of the roadway or exit ramp and the like to be controlled. In one embodiment, length 12 is more than 50% of the width 11 of the roadway. It should be noted that recessed directional rumble strip 1 can be spaced equidistant, in the direction of travel flow, along top surface 2 as shown in FIG. 1. Recessed directional rumble strips can be placed in differing spacing to form recessed directional rumble strip system 10 as shown in FIG. 3 and the recessed directional rumble strip may further be placed at an angle to the wrong way direction 18 as shown in FIG. 4. It should be further noted that multiple recessed directional rumble strips 1 can be placed parallel to one another as shown in FIG. 1, but that any pattern is contemplated by the present disclosure including a herringbone pattern to form recessed directional rumble strip system 10 in FIG. 5, a staggered pattern to form recessed directional rumble strip system 10 in FIG. 6 or an irregular pattern which can comprise any combination of placements disclosed herein or contemplated. It should be appreciated by those skilled in the art that the pattern (or lack of a pattern) of the placement of recessed directional rumble strip will affect the audible and tactile frequency a wrong way driver will experience when travelling in the wrong way direction 18. In addition, it is contemplated that the angled pattern of recessed directional rumble strip system 10 in FIG. 4 may advantageously direct the vehicle of a wrong way driver to veer in the direction of the angle forcing the driver to make a correction to avoid a collision with the side of the roadway (i.e. a guardrail).

As described herein above, recessed directional rumble strip 1 has a rumble face 8 that can have a relatively steep intersection angle with top surface 2. It should be appreciated by those skilled in the art that the steeper the intersection angle, the more acute impact edge 16 is as it is presented to the tire of a wrong way driver as will be described more fully herein after. The recessed directional rumble strip 1 may have sides 13, 14 at each end but may also taper to top surface 2 in other embodiments. A wrong way driver can see rumble face 8 and impact edge 16 if approaching the recessed directional rumble strip 1 in a wrong way direction 18 which is a direction opposite of correct designated direction 15. Recessed directional rumble strip 1 can be configured to be almost imperceptible to a driver travelling in correct designated direction 15. The rumble face 8, impact edge 16 and descending surface 5 are configured to allow a vehicular traffic in correct designated direction 15 to pass over recessed directional rumble strip 1 with little effect on the vehicle or driver. Although shown as a sharp edge, impact edge 16 can comprise any profile that produces a suitable effect on a vehicle passing in the wrong way direction including a curved profile and a chamfered profile. The descending surface 5 may be set at an acute angle, shown relative to top surface 2, for example, as an angle of about 10° to about 35°.

Referring again to FIG. 2, rumble face 8 of recessed directional rumble strip 1 has a relatively steep angle 9 with respect to top surface 2 and presents impact edge 16 to the tire of a wrong way driver which can alert a wrong way driver travelling in the wrong way direction 18 (opposite to correct designated direction 15). In this event, even at a slow speed, the tire of a vehicle would enter recessed directional rumble strip 1 from intersection of sloped face 5 and top surface 2 and encounter steep rumble face 8 and impact edge 16 of recessed directional rumble strip which would be perceived by the driver as a significant obstacle, causing at least a tactile and audible alert to the driver, and a deterrent for vehicles traveling in the wrong direction. The steep rumble face 8 is positioned at an angle, shown as 9, relative to descending surface 5, for example, about 35° to about 100°, typically about 60°. In one embodiment of the invention, total depth 7 can be 3 inches and up to the depth of pavement 3, typically up to 6 inches depending on pavement material.

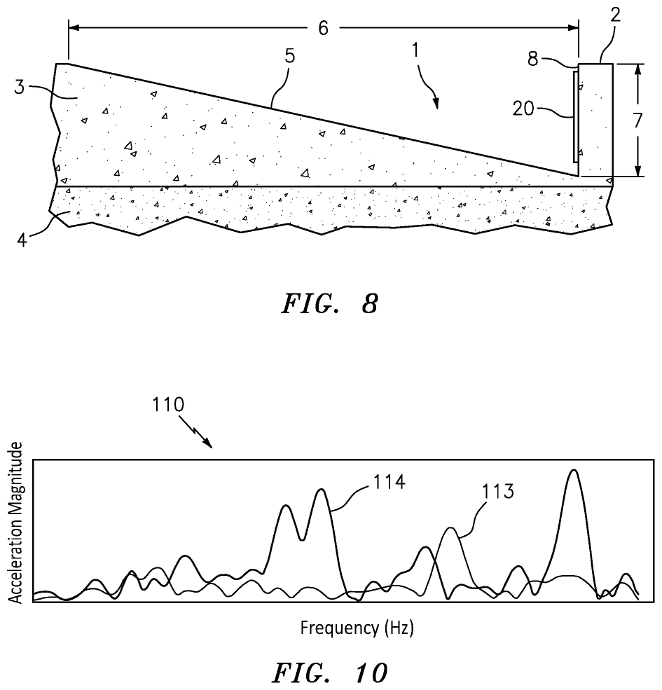

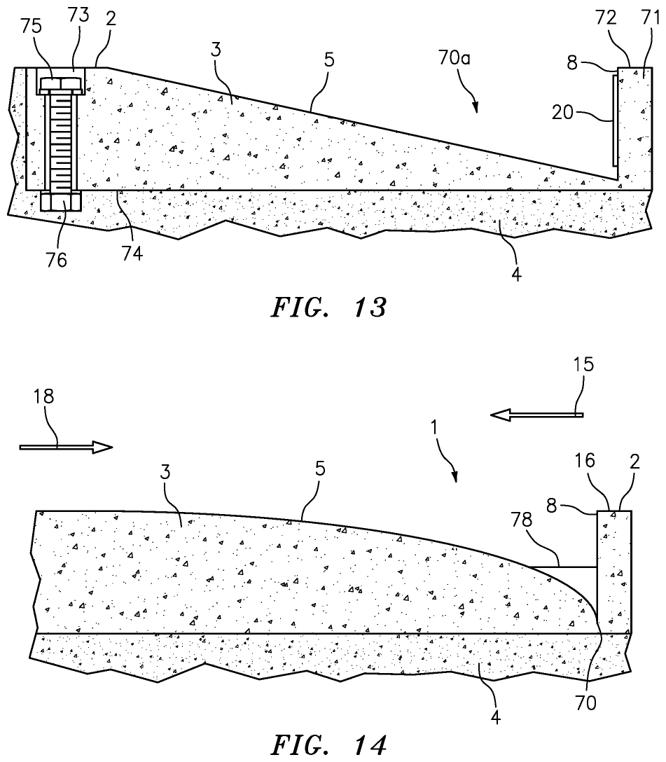

Referring now to FIG. 8, there is shown an embodiment of recessed directional rumble strip 1 wherein rumble face 8 is positioned at approximately 90 degrees relative to top surface 2. In this particular embodiment warning indicia 20 can be seen applied to rumble surface 8. The warning indicia 20 may be painted on rumble surface 8 or may consist of a label, stencil or any other means of marking the surface so that a driver travelling in wrong way direction 18 is able to see the indicia. The warning indicia may simply be of reflective coating or a can recite for example “WRONG WAY” or “DO NOT ENTER”. It is also contemplated that warning indicia 20 could placed be on the pavement 2 or other surface such as on or in front of descending surface 5 such as shown with reference to FIG. 13.

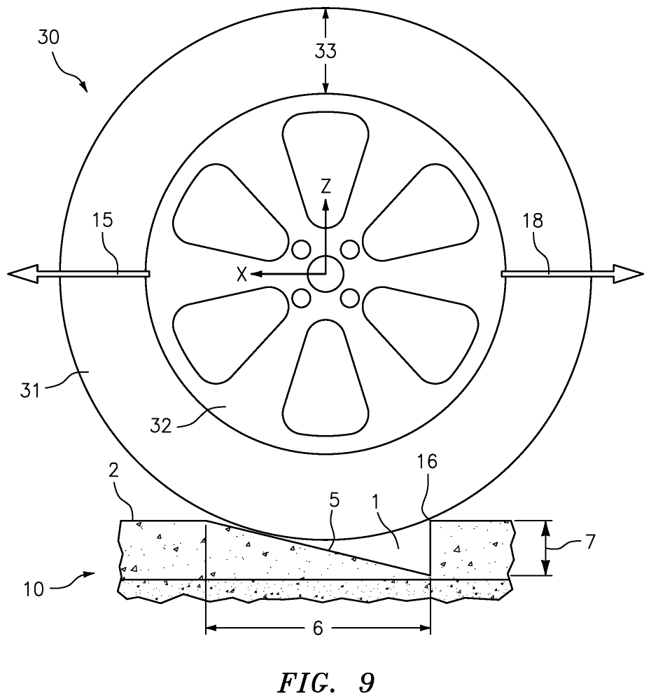

The operation of recessed directional rumble strip system 10 is best shown with reference to FIG. 9, wherein wheel 30 includes a tire 31 and rim 32. In the embodiment shown, rim 32 has a diameter of 19 inches and tire 31 can be a 215 65R19. Such a tire designation can include a sidewall height 33 of approximately 5.51 inches and an outside diameter of about 30 inches. In the embodiment shown, recessed directional rumble strip 1 has a depth 7 of approximately 2.0″ and a width 6 of approximately 12″. It should be apparent that the aforementioned dimension of recessed directional rumble strip system 10 can vary to accommodate tires of different sizes depending on the desired effect. The preselected angle of the sloped surface and the preselected depth 7 are configured to cause an effect on an operating condition of vehicular traffic approaching from a wrong way direction 18 and to have less, little or no effect on an operating condition of vehicular traffic approaching from a correct designated direction 15. In such an embodiment, tire 31 of wheel 30 of a wrong way driver travelling in wrong way direction 18 will leave top surface 2 and travel down descending surface 5 approximately 2″. In continuing to travel in wrong way direction 18, tire 31 will collide with impact edge 16 causing an acceleration in the Z direction and an impact force to be translated to the vehicle. It should be appreciated by those skilled in the art that in addition to the collision of tire 31 with impact edge 16, tire 31 experiences a rapid acceleration in the Z direction that can produce significant dynamic loads that are translated into the vehicle of the wrong way driver. The magnitude of the dynamic loads will depend on many factors such as the diameter of tire 31, depth 6, length 7 and angle 9 of recessed directional rumble strip 1, the speed and weight of the vehicle, the suspension characteristics of the vehicle, the stiffness of the tire and the stiffness of rim 32, among other factors. The loads can be calculated and a method of estimating the loads is given in a Chalmers University of Technology paper titled “Converting dynamic impact events to equivalent static loads in vehicle chassis” authored by Sushanth Shandliya Dattakumar and Vivek Ganeshan and published in 2017, the contents of which are incorporated herein by reference in its entirety (herein after the “Chalmers Paper”). The Chalmers Paper studied the impact loading of vehicle tire encountering a pothole. The Chalmers Paper reported that the peak dynamic loads in the X direction ranged from about 2500N to about 13,600N and in the Z direction the peak dynamic loads ranged from about 15,000N to about 34,000N. Dynamic loads of these magnitudes would be felt by a driver both in terms of the overall reaction of the vehicle as well as the tactile sensation through the steering wheel. In addition, such large dynamic forces can produce a significant audible signal (sound) that can be heard by the driver as well as by sensors positioned nearby as will be described more fully herein after. A wrong way driver encountering a recessed directional rumble strip system 10 would experience multiple impacts with successive recessed directional rumble strip 1 and it would alert the driver that the vehicle was travelling in the wrong way direction 18. Still referring to FIG. 9, tire 31 of a vehicle approaching recessed directional rumble strip 1 in the correct designated direction 15 would roll off of top surface 2 and encounter descending surface 5 and would continue to translate up the sloped surface and back onto to the top surface without encountering any impact. In certain embodiments vehicular traffic approaching recessed directional rumble strip 1 in the correct designated direction 15 may encounter little or no perceivable effect. In alternative embodiments, and consistent with present disclosure, depending on specific factors of the place, shape and dimensions of recessed directional rumble strip 1, the wrong way direction 18 and the correct designated direction 15 can be reversed wherein a tire of a vehicle approaching from a wrong way direction would encounter rumble face 8 first and then contact declining surface 5 and produce the aforementioned conditions on the vehicle in a greater manner than a vehicle approaching from the opposite correct designated direction.

Referring now to FIG. 10, there is shown modelling data for the embodiment of recessed directional rumble strip 1 of FIG. 9 having a depth 7 of approximately 2.0″ and a width 6 of approximately 12″. The data shown was obtained using a commercially available vehicle dynamics software system capable of modeling various full vehicle maneuvers, tire-road impact, and analysis of individual systems such as suspension systems. The model chosen for the analysis was a sedan with a total weight of about 3900 lbf and an unloaded tire radius of 326 mm. Graph 110 plots the magnitude of acceleration on the Y axis 111 against the frequency of the acceleration on the X axis 112 for frequencies from 0 Hz to approximately 15 Hz. The accelerations were modelled at the driver seat and are along the Z direction (FIG. 9) for a car travelling at 10 mph and encountering recessed direction rumble strip 1. Line 113 is the acceleration response for a vehicle travelling in the correct designated direction 15 and line 114 is the acceleration response for a vehicle travelling in the wrong way direction 18. As is illustrated in graph 110 the acceleration response of a vehicle travelling in the wrong way direction is almost consistently higher than the acceleration response of a vehicle travelling in the wrong way direction along the frequency range modelled. It should be appreciated by those skilled in the art that a statistically significant difference exists between the mean values of acceleration for right and wrong way directions. This modelling data cause proves that the asymmetric features of recessed directional rumble strip 1 would have an effect on an operating condition, acceleration in this instance, of vehicular traffic approaching from a wrong way direction 18 and to have statistically less effect on an operating condition of vehicular traffic approaching from a correct designated direction 15.

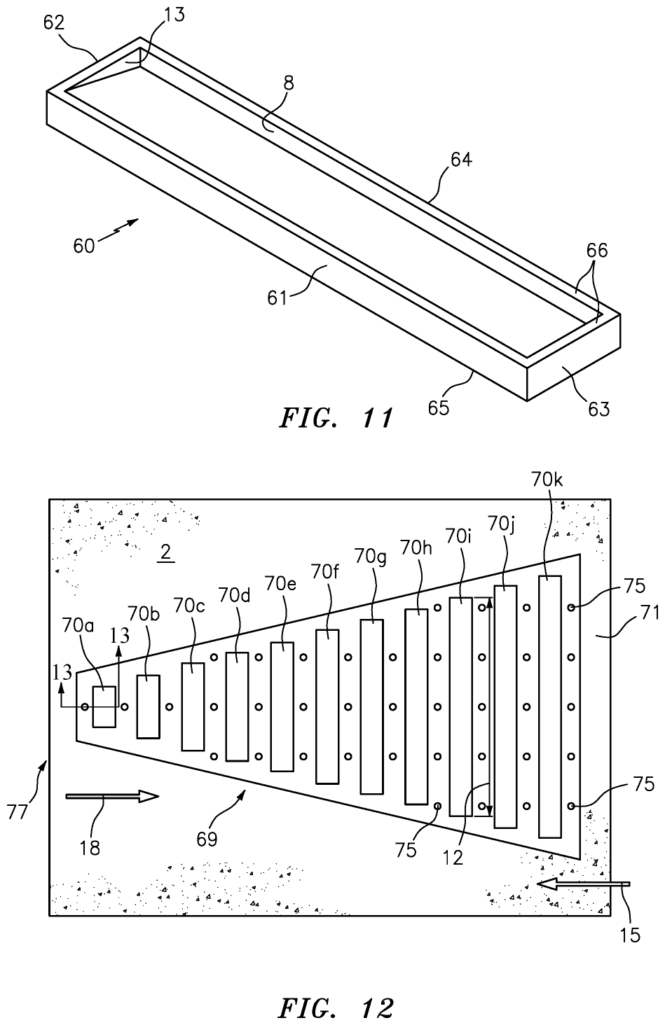

Referring now to FIG. 11, there is shown a directional rumble strip module in the form of modular recessed directional rumble strip 60 which is similar in functional shape to that described herein above and includes sides 13, descending surface 5 and rumble face 8. Modular recessed directional rumble strip 60 further includes front side 61, left end 62, right end 63, back side 64, bottom 65 and top surface 66. In this particular embodiment, the features of modular recessed directional rumble strip 60 are engineered and fabricated prior to installation into pavement layer 3 (FIG. 8). Modular recessed directional rumble strip 60 can be manufactured using any known technique such as machining, casting, molding and the like. In operation, a recess (not shown) is positioned in pavement layer 3 accommodating the outside dimensions of front side 61, left end 62, right end 63, back side 64 and bottom 65 and modular recessed directional rumble strip 60 is disposed within the recess such that top surface 66 is substantially flush with the top surface of the pavement 2 (FIG. 13) such that the modular recessed directional rumble strip produces substantially similar effects to that described herein above with respect to recessed directional rumble strip 1. Modular recessed directional rumble strip 60 can be made from any known material such as plastic, asphalt, concrete metal so long as it is compatible with the material from which pavement layer 3 is comprised. It should be appreciated by those skilled in the art that modular recessed directional rumble strip 60 should be comprised of material that is complaint with at least the stiffness, creep, and coefficient of thermal expansion of pavement layer 3. Modular recessed directional rumble strip 60 can be fixed within the aforementioned recess by placing anchors in the recess and bolting the modular recessed directional rumble strip to the anchors (FIG. 13) and providing a resilient caulking material around the front side 61, left end 62, right end 63 and back side 64 to prevent water ingression. It is also contemplated by the present disclosure that modular recessed directional rumble strip 60 can be fixed within the recess by bonding, cementing or other suitable known technique. It is further contemplated by the present disclosure that an energy absorbing material (not shown) can be place between bottom 65 of modular recessed directional rumble strip 60 and the recess such that loads from vehicles that are perpendicular to the pavement surface 2 can be absorbed. It should be appreciated that the interface between back side 64 and the recess should be as rigid as possible to produce the desired tactile sensation and audible response to a vehicle drive in the wrong way direction 18 (FIG. 1) described herein above.

Referring to FIGS. 12 and 13, there is shown a modular recessed directional rumble strip system 69 comprised of a plurality of recessed directional rumble strip 70a-70k. recessed directional rumble strip 70a-70k are substantially similar to recessed directional rumble strip 1 and recessed directional rumble strip 60 described herein above and produce substantially similar effects to that described herein above with respect to afore described recessed directional rumble strip. In the embodiment shown, recessed directional rumble strip system 69 includes a body 71 into which recessed directional rumble strips 70a-70k are disposed below the surface 72 of the body and a plurality of mounting holes 73 are positioned through the body. In operation, the features of modular recessed directional rumble strip system 69 are engineered and fabricated prior to installation into pavement layer 3. Modular recessed directional rumble strip system 69 can be made from any known material such as plastic, asphalt, concrete metal so long as it is compatible with the material from which pavement layer 3 is comprised. Modular recessed directional rumble strip system 69 can be manufactured using any known technique such as machining, casting, molding and the like. In operation, a recess 74 is positioned below pavement surface 2 and into pavement layer 3 accommodating the outside dimensions of body 71 and depth of modular recessed directional rumble strip system 69. Similar to that described herein above with respect to modular recessed directional rumble strip 60. modular recessed directional rumble strip system 69 should be comprised of material that is complaint with at least the stiffness, creep, and coefficient of thermal expansion of pavement layer 3. Modular recessed directional rumble strip system 69 is then disposed within recess 74 such that top surface 72 is substantially flush with top surface of the pavement 2. Modular recessed directional rumble strip system 69 can be fixed to pavement layer 3 via fasteners 75 positioned within mounting holes 73 and below top surface 72 and threadably engaged within anchor nuts 76 fixed within pavement layer 3. It is within the scope of the present disclosure that fasteners 75 can be installed in pavement layer 3 to locate the mounting holes of modular recessed directional rumble strip system 69 and nuts 76 could then be applied to the fasteners after the modular recessed directional rumble strip system is positioned within recess 74. Once the fasteners are installed and modular recessed directional rumble strip system 69 is fixed within recess 74 caps (not shown) can be applied over fasteners 75, or alternatively holes 73 can be filled with a caulking material or adhesive to be flush with top surface 72.

Referring again to FIGS. 12 and 13, recessed directional rumble strip 70a-70k are shown in this particular embodiment as ranging in increasing widths 12 across pavement surface 2 in the wrong way direction 18. It is contemplated by the present disclosure that modular recessed directional rumble strip system 69 can be positioned at an end 77 of an exit ramp of a freeway (end with respect to correct designated direction 15) with recessed directional rumble strip 70 positioned at or near the stop line or yield line markings (not shown) on pavement surface 2. Although the widths 12 can be uniform, the increasing widths would produce a varying vibrational and auditory effect on a driver travelling in the wrong way direction 18. In addition, the pattern established by the increasing widths 12, together with indicia 20, would produce a unique visual effect on a driver travelling in the wrong way direction 18. Although shown uniformly spaced apart, recessed directional rumble strip 70a-70k can be positioned within body 71 at various spacing without departing from the scope of the present disclosure. In addition, the shape, depth 6 and length 7 of recessed directional rumble strip 70a-70k can be uniform or vary between the plurality of recessed directional rumble strip.

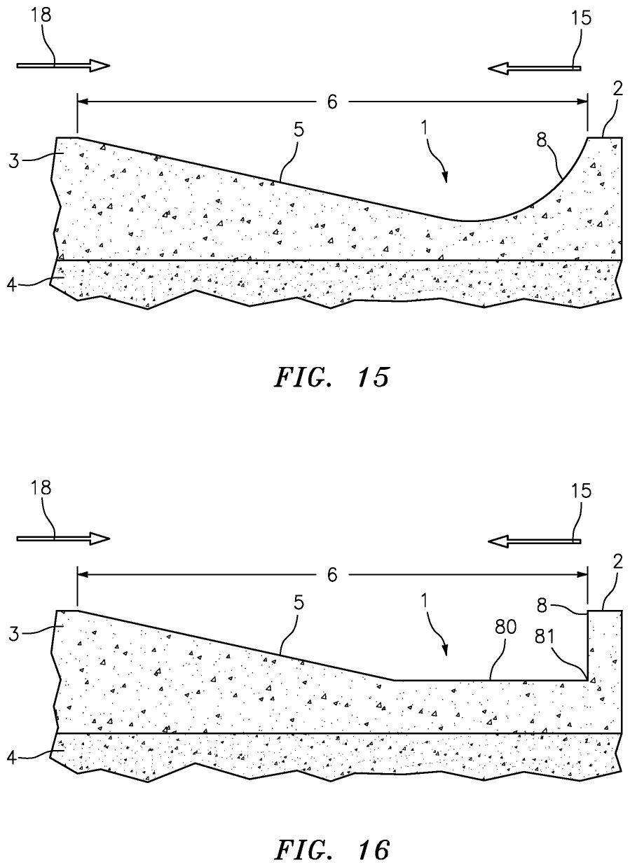

Although described herein as having a rumble face 8 and descending surface 5 that approximate planar surfaces, it is within the scope of the present disclosure that these features can include curved and curvilinear surfaces positioned at an angle such as shown with reference to FIG. 14. In this alternative embodiment, descending surface 5 of recessed directional rumble strip 1 is comprised of a curvilinear shape that begins at pavement surface 2 and slopes down at an increasingly tighter radius, although any curve is contemplated, until it meets rumble face 8 at intersection 70. Now with further reference to FIG. 15, rumble face 8 can be curved or curvilinear. A tire of a vehicle entering recessed directional rumble strip 1 from correct designated direction 15 would roll off pavement surface 2 and onto descending surface 5 without impacting any edges and having less, little to no effect on the right way driver. A tire of a vehicle entering recessed directional rumble strip 1 from wrong way direction 18 would roll down descending surface 5, enter curved rumble face 8 producing the aforementioned vibrational and auditory effects. Although shown as a specific curvilinear shape, alternative shapes for descending surface 5 and rumble face 8 are contemplated by the present disclosure. In addition, a truncated curvilinear sloped surface is contemplated in other embodiments wherein a transition would be made between descending surface 5 and intersection 70 indicated by dashed line 78 (FIG. 14). In addition, and with reference back to FIG. 1, it is further within the scope of the present disclosure that recessed directional rumble strip 1 can have varying spacing between successive recessed directional rumble strip as well as various sized and shaped recessed directional rumble strip as disclosed herein.

Referring now to FIG. 16, there is shown an alternative embodiment wherein descending surface 5 of recessed directional rumble strip 1 includes a transition surface 80 extending to intersection 81 with rumble face 8. Similar to that described immediately herein above, a tire of a vehicle entering recessed directional rumble strip 1 from correct designated direction 15 would roll off pavement surface 2 and onto descending surface 5 without impacting any edges and having little to no effect on the right way driver. A tire of a vehicle entering recessed directional rumble strip 1 from wrong way direction 18 would roll down descending surface 5 until the tire strikes impact edge 16 producing the aforementioned vibrational and auditory effects. Although shown as a transitional shape, alternative shapes for descending surface 5 are contemplated by the present disclosure.

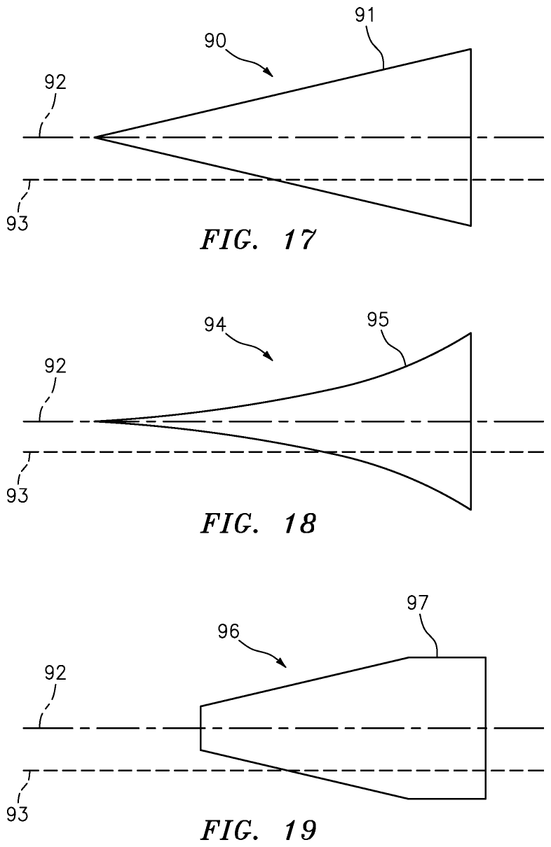

As described herein above, any known or contemplated method of manufacturing recessed directional rumble strip is within the scope of the present disclosure. It should be appreciated by those skilled in the art that the recessed directional rumble strip of the present disclosure differs from those of the prior art at least in that its recessed shape is asymmetrical along its width 6. Rather, the recessed directional rumble strip disclosed herein are asymmetrically profiled along width 6. In this regard, pavement milling machines of the prior art having cylindrical cutting drums, as disclosed herein above, are unsuitable for manufacturing recessed directional rumble strip of the present disclosure. Referring now to FIG. 17 there is shown a profiled cutting drum 90 having an outside profile 91 suitable for manufacturing the profile of the embodiment of recessed directional rumble strip 1 disclosed with reference to FIG. 8. In this particular embodiment, and with reference also to FIG. 8, cutting heads, or other suitable abrasive or cutting features, are arranged on cutting drum 90 to provide for the profile 91 for manufacturing the embodiment of recessed directional rumble strip 1. In operation, drum 90 can be mounted to a milling machine (not shown) and rotated about centerline 92 by any known means and is disposed generally parallel to the surface of the roadway depicted by line 93. Cutting drum 90 is maintained at a predetermined position with respect to the surface of the roadway 93 such that the cutting teeth cut into the surface creating the asymmetric non-constant predetermined depth across width 6. As cutting drum 90 is rotated about its centerline 92 the milling machine is advanced along the length 12 of surface 2 of the roadway (FIG. 1) to produce recessed directional rumble strip 1. It is not contemplated or necessarily desirable that the depth of each recessed directional rumble strip be constant across its length 12. In fact, the depth of each recessed directional rumble strip can vary across its length 12, with the shallowest points being located at the center and ends 13, 14. Preferably, hydraulic or other means are provided (not shown) for moving cutting drum 90 upwardly and downwardly. Upwardly such that cutting drum 90 is out of contact with the surface 2 of the roadway in order to move the milling machine into position to begin the cutting recessed directional rumble strip 1, and downwardly to bring the cutting drum to the predetermined position with respect to the surface 2 of the roadway for cutting. Referring now to FIG. 18, there is shown a profiled cutting drum 94 having an outside profile 95 suitable for manufacturing the profile of the embodiment of recessed directional rumble strip 1 disclosed with reference to FIG. 14. In this particular embodiment, and with reference also to FIG. 14, cutting heads, or other suitable abrasive or cutting features, are arranged on profiled cutting drum 94 to provide for the profile 95 for manufacturing the embodiment of recessed directional rumble strip 1 similar to that disclosed herein above with reference to FIG. 17. Referring now to FIG. 19, there is shown a profiled cutting drum 96 having an outside profile 97 suitable for manufacturing the profile of the embodiment of recessed directional rumble strip 1 disclosed with reference to FIG. 16. In this particular embodiment, and with reference also to FIG. 16, cutting heads, or other suitable abrasive or cutting features, are arranged on profiled cutting drum 96 to provide for the profile 97 for manufacturing the embodiment of recessed directional rumble strip 1 similar to that disclosed herein above with reference to FIG. 17.

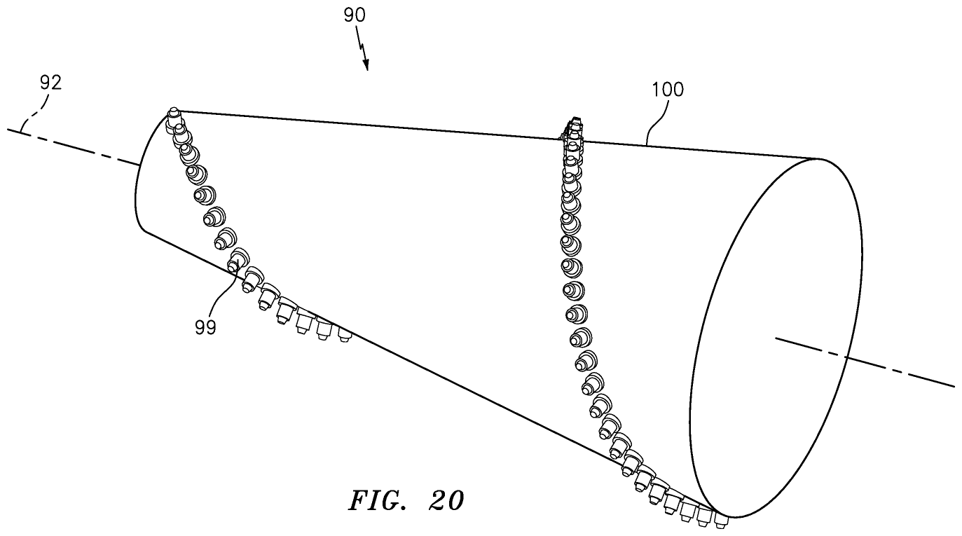

Referring now to FIG. 20 there is shown a particular embodiment of profiled cutting drum 90 that shows a generally frustoconical cutting drum, having a plurality of cutting teeth 99 mounted on the outer surface 100 thereof. Cutting teeth 99 can be comprised of a highly wear resistant steel body that is tipped with a tungsten carbide insert, or other suitable material. Cutting teeth 99 can be similar to those used in prior art milling machines. In the embodiment shown, cutting teeth 99 are arranged in a predetermined pattern around drum 90 to produce the profile 91 (FIG. 17) to provide the shape of recessed directional rumble strip 1 of FIG. 8. The pattern is selected, along with the size of cutting teeth 99, direction and speed of rotation of the drum about centerline 92 and the speed of advancement of the milling machine (not shown) along the roadway, to produce a recessed directional rumble strip 1. The pattern shown in FIG. 20, is an interrupted helical pattern, although cutting teeth 99 may be arranged in a variety of patterns which may be configured to cut a recessed directional rumble strip 1 when profiled cutting drum 90 is rotated about centerline 92 while being maintained at a predetermined position with respect to the surface 2 of the roadway. Profiled cutting drum 90 may be provided in a variety of lengths and diameters, and teeth 99 may be provided thereon in such numbers and patterns that recessed directional rumble strip 1 of any desired width 6 and profile may be produced. In addition to the length and frustoconical shape of profiled cutting drum 90, and the number, arrangement and positioning of cutting teeth 99, the rate of rotation of drum 90 about centerline 92 with respect to the speed of the milling machine can be adjusted to produce recessed directional rumble strip 1 of various profiles. It is contemplated that drum 90 and cutting teeth 99 may be provided in any convenient size and configuration, including that which will permit the cutting of recessed directional rumble strip of up to approximately twenty inches in width 6. In addition, the pattern of teeth 99 and the angle of centerline 92 with respect to the width 11 of the roadway can be selected to orient the recessed directional rumble strip 1 at any desired angle with respect to the wrong way direction 18 of travel (FIG. 1).

Referring back to FIG. 1, recessed directional rumble strip system 10 further includes sensor station 50. Sensor station 50 is positioned proximate recessed directional rumble strip 1 and is configured to sense environmental factors that are produced by a change in an operating condition when a vehicle encounters recessed directional rumble strip system 10 while travelling in the wrong way direction 18. Such environmental factors indicative of vehicular traffic travelling in the wrong way direction 18 are produced by a change in an operating condition of a vehicle when it encounters a recessed directional rumble strip and can include acceleration, sound, pressure, vibration and the like. In the aforementioned audible noise signal produced by the high dynamic loads produced when a vehicle encounters recessed directional rumble strip system 10 while travelling in the wrong way direction 18, sensor station 50 can include at least one sound sensor, such as a microphone, a vibration sensor, a directional sensor, a temperature sensor and the like. Sensor station 50 can further include computer processing equipment configured to process a signal produced by a microphone and to compare the signal to a known signal indicative of a vehicle traveling in the wrong way direction 18. Sensor station 50 can also include artificial intelligence and machine learning techniques capable of learning a plurality of sound signatures of operating conditions indicative of various vehicles traveling in the wrong way direction 18 including multiple variables such as weather, speed, vehicle weight and the like. Sensor station 50 can include the capability of producing an output signal indicative of a vehicle traveling in the wrong way direction 18 wherein the output signal can trigger an alarm such as a speaker, signage or a light (not shown). Sensor station 50 can also include a communication module to either wirelessly or through wired systems (not shown) communicate the output signal indicative of a wrong way event to police or other authorities. Although a single sensor station is shown, other embodiments that include a plurality of sensor and stations is contemplated by this disclosure.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated other The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

While the foregoing is directed to embodiments of the present invention, other and further embodiments of the invention may be devised without departing from the basic scope thereof, and the scope thereof is determined by the claims that follow.

1-36. (canceled)

37. A recessed directional rumble strip comprising:
a descending surface projecting downwardly from a top surface of a pavement of a roadway; and
a rumble face descending from the top surface of the pavement.

38. The recessed directional rumble strip of claim 1 wherein at least a portion of the rumble face comprises a curved profile.

39. The recessed directional rumble strip of claim 2, further comprising a length that traverses at least a portion of the roadway.

40. The recessed directional rumble strip of claim 3 further comprising a width and wherein the width and a depth are configured to cause a first effect on an operating condition of vehicular traffic approaching from a wrong way direction and wherein the width and the depth are selected to have a second effect on an operating condition of vehicular traffic approaching from a correct designated direction wherein the first effect is greater than the second effect.

41. The recessed directional rumble strip of claim 4 further comprising an impact edge formed at an intersection between the rumble face and the top surface of the pavement.

42. The recessed directional rumble strip of claim 5 wherein the first effect is caused by an interaction of a tire with the recessed directional rumble strip of vehicular traffic approaching from the wrong way direction.

43. The recessed directional rumble strip of claim 4 wherein the first effect on the operating condition is at least one of an acceleration, an impact force, a tactile sensation, a speed, an audible noise signal and a vibration.

44. The recessed directional rumble strip of claim 1, further comprising a first angle between the descending surface and the top surface of the pavement and wherein the first angle is between about 10 and about 35 degrees and a second angle between the top surface and the rumble face and wherein the second angle is between about 35 and about 100 degrees.

45. The recessed directional rumble strip of claim 7, further comprising at least one sensor positioned proximate the recessed directional rumble strip wherein the at least one sensor is configured to sense the operating condition.

46. The recessed directional rumble strip of claim 9, wherein the at least one sensor includes at least one of one a sound sensor, a microphone, a vibration sensor, a directional sensor and a temperature sensor.

47. The recessed directional rumble strip of claim 10, further comprising a sensor station comprising computer processing equipment configured to process a signal produced by at least sensor and is further configured to produce an output signal indicative of a vehicle traveling in the wrong way direction.

48. The recessed directional rumble strip of claim 11 wherein the computer processing equipment is configured to employ machine learning techniques to learn a plurality of operating conditions indicative of vehicular traffic traveling in the wrong way direction.

49. The recessed directional rumble strip of claim 4, wherein the first effect is configured to deter vehicular traffic travelling in the wrong way direction.

50. A recessed directional rumble strip system comprising:
a plurality of recessed directional rumble strips positioned below a top surface of a pavement of a roadway, the plurality of recessed directional rumble strips comprising:
a descending surface descending from the top surface of the pavement; and
a rumble face descending from the top surface of the pavement.

51. The recessed directional rumble strip system of claim 14 wherein at least a portion of the rumble face comprises a curved profile.

52. The recessed directional rumble strip system of claim 15, further comprising the plurality of recessed directional rumble strips comprising a length that traverses at least a portion of the roadway.

53. The recessed directional rumble strip system of claim 16, further comprising a first angle between the descending surface and the top surface of the pavement and a second angle between the top surface and the rumble face wherein the second angle and a depth of the plurality of recessed directional rumble strips are configured to cause a first effect on an operating condition of vehicular traffic approaching from a wrong way direction and wherein the second angle and the depth are configured to cause a second effect on an operating condition of vehicular traffic approaching from a correct designated direction wherein the first effect is greater than the second effect.

54. The recessed directional rumble strip system of claim 17, wherein the plurality of recessed directional rumble strips are positioned at any of evenly spaced along the top surface of the pavement and at varying spacing along the top surface of the pavement.

55. The recessed directional rumble strip system of claim 18, wherein the plurality of recessed directional rumble strips are positioned at any of perpendicular to the wrong way direction, at an angle other than perpendicular to the wrong way direction and in a pattern.

56. The recessed directional rumble strip system of claim 19, further comprising at least one sensor positioned proximate the plurality of recessed directional rumble strips wherein the at least one sensor is configured to sense an environmental factor indicative of a vehicle traveling in the wrong way direction and a sensor station in communication with the at least one sensor, the sensor station comprising computer processing equipment configured to process a signal related to the environmental factor and to produce an output signal indicative of a vehicle traveling in the wrong way direction and wherein the computer processing equipment is configured to employ machine learning techniques to learn a plurality of operating conditions indicative of vehicular traffic traveling in the wrong way direction.

57. The method of deterring wrong way drivers on a roadway comprising:
positioning a plurality of recessed directional rumble strips below a top surface of pavement of the roadway, the plurality of recessed directional rumble strip comprising:
a descending surface descending from the top surface of the pavement;
a rumble face descending from the top surface of the pavement; and
wherein at least a portion of the rumble face comprises a curved profile.
